(19) United States
(12) Patent Application Publication
(10) Pub. No.: US 2017/0263392 A1
(43) Pub. Date: Sep. 14, 2017

(54) Keyboard Structure

(71) Applicant: I-Rocks Technology Co., Ltd., New Taipei City (TW)

(72) Inventor: Ching-Shi Fong, New Taipei City (TW)

(21) Appl. No.: 15/231,788

(22) Filed: Aug. 9, 2016

(30) Foreign Application Priority Data
Mar. 11, 2016 (TW) 105203428

(51) Int. Cl. H01H 13/86

(52) U.S. Cl. CPC H01H 13/86

(57) ABSTRACT

A keyboard structure includes a main body, on which a plurality of keystrokes and a upper surface are configured, where binding members are configured on the upper surface so that building blocks can be combined with the keyboard through the binding members, allowing the surface of the main body to be decorated. Furthermore, the binding members may be configured on a mounting element, and the mounting element is then combined with the main body in such a way that the main body can have the binding members adapted to be in combination with building blocks similarly.

### (A) TECHNICAL FIELD OF THE INVENTION

The present invention relates to a keyboard, and more particularly to a keyboard structure allowing a user to decorate the surface of a keyboard body.

### (B) DESCRIPTION OF THE PRIOR ART

To satisfy use convenience demands, computers are always equipped with a variety of peripheral input devices such as keyboard, mouse and touch panel. Users may generate input signals by means of a pressing, sliding or rolling sensing device through the peripheral input devices, and the peripheral input devices convert the input signals into output signals and transfer them to a computer so as to control the computer or input information into it.

The keyboard function is only inputting information to computers simply as mentioned above without other functions. In addition, the surfaces of keyboards are printed with a manufacturer name at most, making users unable to do more decorations or variations.

### SUMMARY OF THE INVENTION

To overcome the defects mentioned above and allow users to do decorations on the surface of a keyboard body, the present invention is proposed.

The main body of the present invention is to provide a keyboard structure, allowing a user to do a variety of changes and decorations through binding members so that the original monotonous keyboard main body becomes more fun.

To achieve the object mentioned above, the present invention is to provide a keyboard structure, including a main body, keystrokes and binding members, where the keystrokes are configured on the main body and the main body further has a upper surface, where the binding members are configured on the upper surface; the binding members are mainly suited to be in combination and engagement with building blocks. Thereupon, when to modify the main body, a user may choose building blocks that they want, and then engage them with the binding members in the range of the upper surface.

### BRIEF DESCRIPTION OF THE DRAWINGS

FIG. 1 is a perspective view of a preferred embodiment of the present invention;

FIG. 2 is a perspective view of the embodiment of the present invention with which building blocks are combined;

FIG. 3 is an exploded view of another preferred embodiment of the present invention;

FIG. 4 is a cross-sectional view of the embodiment of the present invention shown in FIG. 3; and

FIG. 5 is a perspective view of the present invention shown in FIG. 3 upon implementation.

### DETAILED DESCRIPTION OF THE PREFERRED EMBODIMENTS

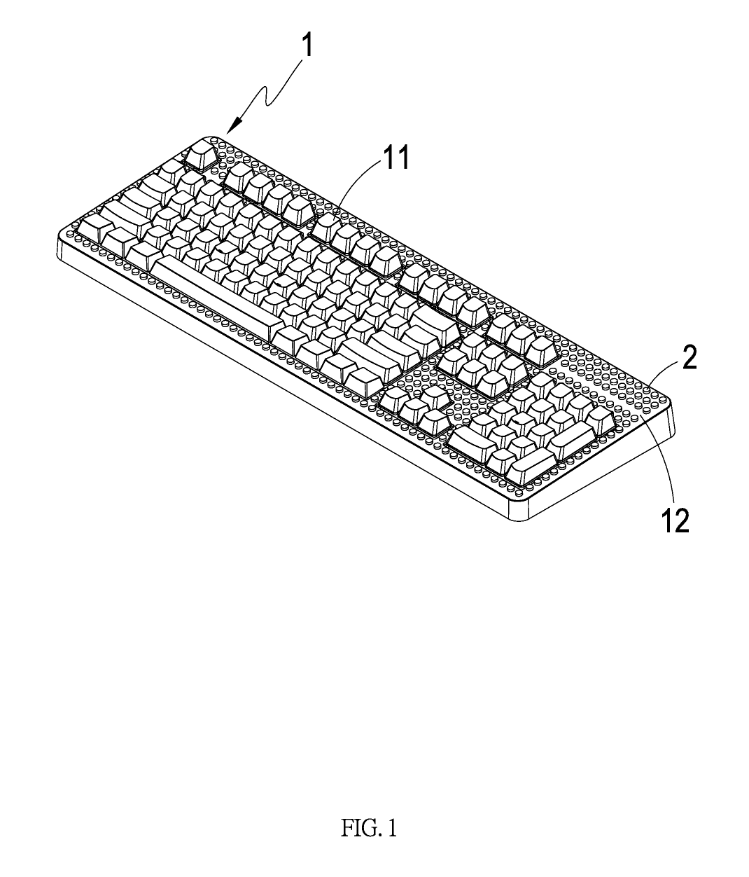

Referring to FIG. 1, which is a perspective view of a preferred embodiment of the present invention, it can be clearly seen that a keyboard structure of the present invention includes:

a main body 1, configured with a plurality of keystrokes 11 and having a upper surface 12; and

at least one binding member 2, configured on the upper surface 12 of the main body 1, and allowing building blocks to be in engagement and combination therewith, the binding member 2 being a protrusion.

The building block is a modeling, rectangular, curved or irregular building block.

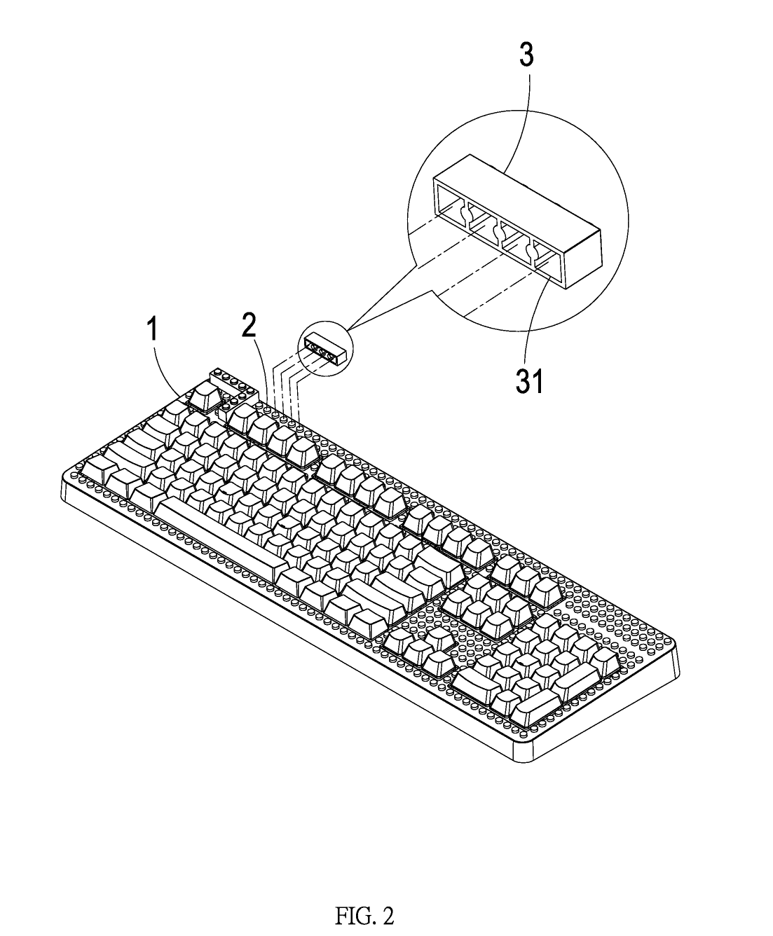

Referring to FIGS. 1 and 2, which respectively are perspective views of a preferred embodiment of the present invention without and with building blocks in combination therewith, it can be clearly seen from the figures that when to decorate the main body 1, building blocks 3 can be in combination with the binding members 2 because one or more binding members 2 are configured on the main body 1 and the shape of each binding member 2 is exactly the same as a positioning portion 31 of the building block 3. A user may first choose the building block 3 to be decorated, and then decide an engagement position. Thereafter, the positioning portions 31 of the building block 3 can then aligned with the binding members 2, and then engaged with and fixed to them; the building block 3 can be engaged with the binding members 2 at all the configuration positions thereof.

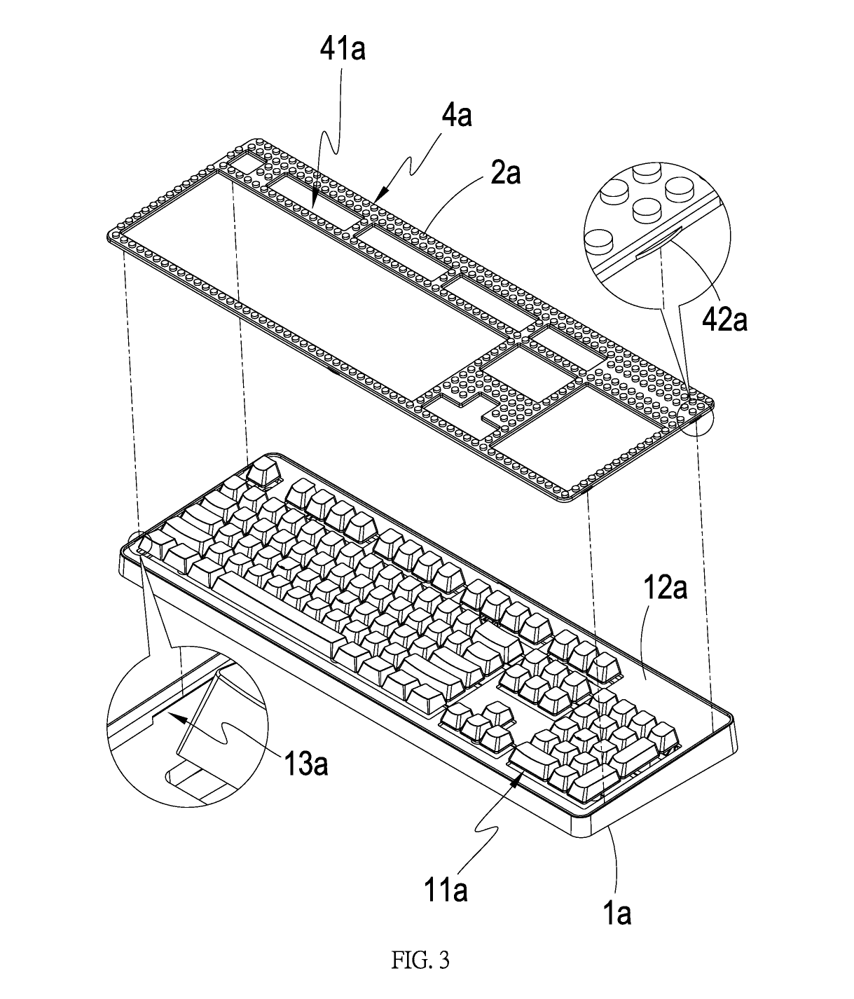

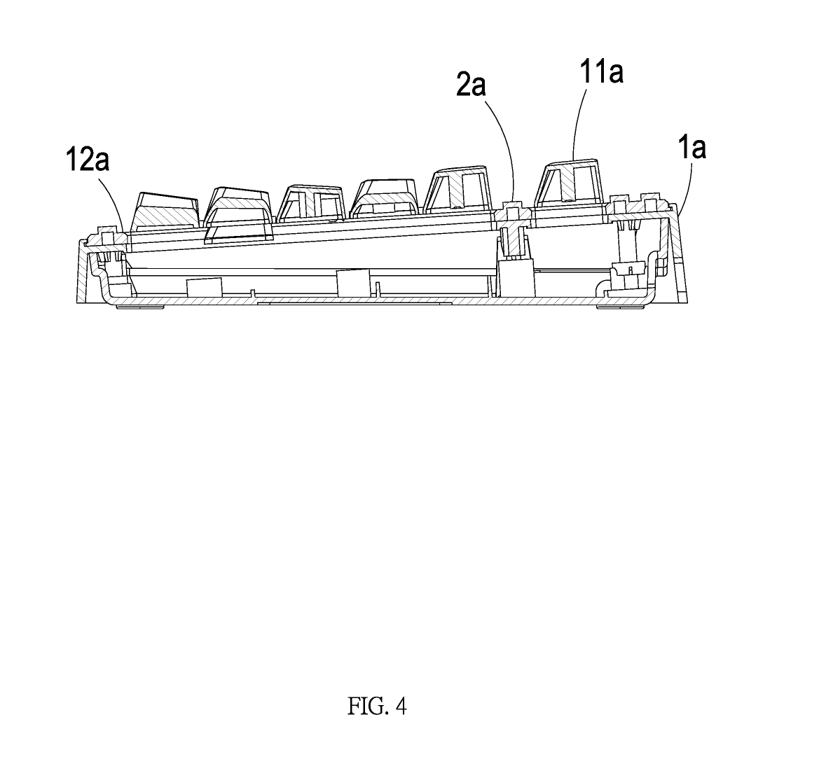

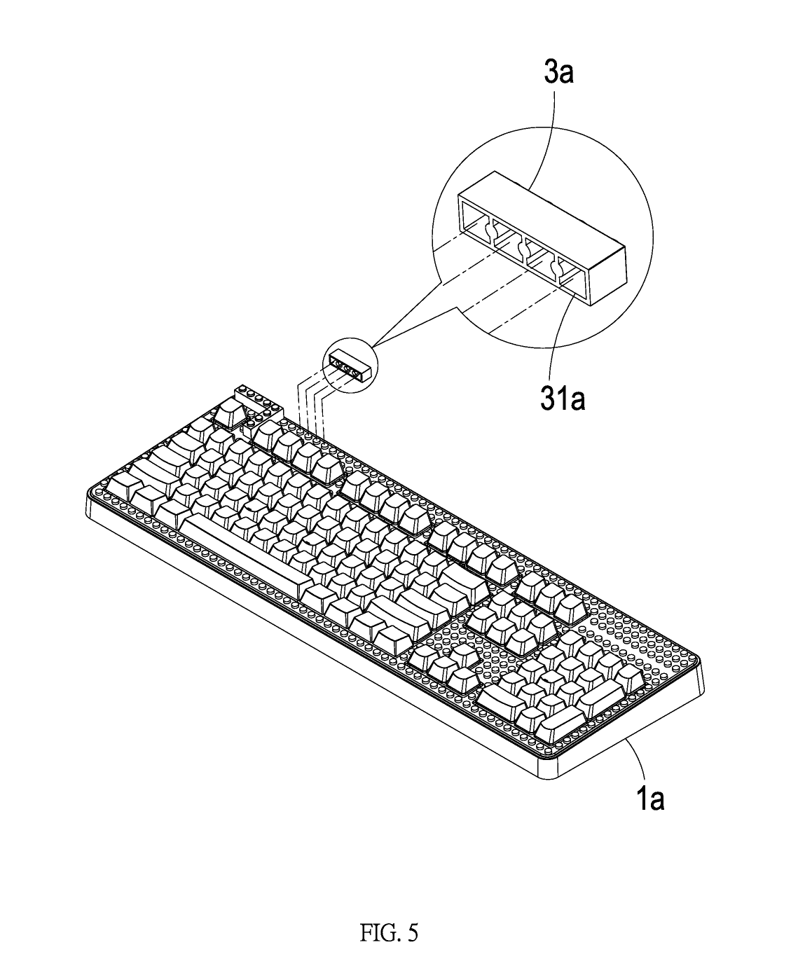

Referring to FIGS. 3 to 5, which respectively are an exploded view, cross-sectional and implementation perspective view of another preferred embodiment of the present invention, it can be clearly seen that a keyboard structure of the present invention includes:

a main body 1, configured with a plurality of keystrokes 11a, and having a upper surface 12a and at least one fixing portion 13a;

a mounting element 4a, installed on the upper surface 12a, and including a plurality of through holes 41a each corresponding to each keystroke 11a, at least one engagement portion 42a capable of being in engagement with the fixing portion 13a being further configured on the mounting element 4a; and

at least one binding member 2, configured on the mounting element 4a, and allowing a building block 3a to be in engagement and combination therewith, the binding member 2a being a protrusion.

Furthermore, the building block 3a has a positioning portion 31a capable of being in engagement with the binding member 2a.

Thereupon, when a user wants to install the building block 3a on the main body 1a, they may align the through holes 41a of the mounting element 4a with the respective keystrokes 11a, and then place and cover it on the upper surface 12a. At the same time, the mounting element 4a is in combination with the main body 1a by engaging the engagement 42a with the fixing portion 13a. Whereby, a user may then choose the building block 3a to be decorated, and align the positioning portions 31a with the binding member 2a to carry out the engagement, which is very convenient.

I claim:

1. A keyboard structure, comprising:
a main body, configured with a plurality of keystrokes, and having a upper surface; and
at least one binding member, configured on a upper surface of said main body, and allowing building blocks to be in engagement and combination therewith.

2. A keyboard structure, comprising:
a main body, configured with a plurality of keystrokes, and having a upper surface;
a mounting element, configured on said upper surface; and
at least one binding member, configured on said mounting element, and allowing building blocks to be in engagement and combination therewith.

3. The structure according to claim 1, wherein said binding member is a protrusion.

4. The structure according to claim 2, wherein said binding member is a protrusion.

5. The structure according to claim 2, wherein said mounting element comprises a plurality of through holes each corresponding to each said keystroke.

6. The structure according to claim 2, wherein at least one fixing portion is configured on said main body.

7. The structure according to claim 6, wherein at least one engagement portion adapted to be in engagement with said fixing portion is configured on said mounting element.

8. The structure according to claim 1, wherein said building block has a positioning portion adapted to be engagement with said binding member.

9. The structure according to claim 2, wherein said building block has a positioning portion adapted to be engagement with said binding member.

10. The structure according to claim 1, wherein said building block is a modeling, rectangular, curved or irregular building block.

11. The structure according to claim 2, wherein said building block is a modeling, rectangular, curved or irregular building block.
